(19) United States
(12) Patent Application Publication
(10) Pub. No.: US 2016/0217164 A1
(43) Pub. Date: Jul. 28, 2016

(54) SPARSE DISTRIBUTED REPRESENTATION OF SPATIAL-TEMPORAL DATA

(71) Applicant: Numenta, Inc., Redwood City, CA (US)

(72) Inventors: Jeffrey C. Hawkins, Atherton, CA (US); Chetan Surpur, Cupertino, CA (US); Scott M. Purdy, San Francisco, CA (US)

(21) Appl. No.: 14/607,915

(22) Filed: Jan. 28, 2015

(51) Int. Cl. G06F 17/30; G06N 99/00

(52) U.S. Cl. CPC G06F 17/30312; G06N 99/005

(57) ABSTRACT

Coordinate data is encoded as a distributed representation for processing and analysis by a machine-intelligence system such as a hierarchical temporal memory system. Input coordinates represented in coordinate space having at least one dimension are obtained. The input coordinates change over time. A corresponding region around each of the input coordinates in the coordinate space is determined. A subset of coordinates within the corresponding region for each of the input coordinates is selected. A distributed representation for each of the input coordinates reflecting the selected subset of coordinates for each of the input coordinates is generated. The distributed representation may be provided to one or more processing nodes for detection of temporal sequences and spatial patterns. Based on discrepancies between predicted coordinate data and actual coordinate data, anomalies may be detected.

### BACKGROUND

1. Field of the Disclosure

The disclosure relates to encoding data for input to a machine-intelligence system, and more particularly to representing a multi-dimensional coordinate space as sparse distributed representations for input to a machine-intelligence system.

2. Description of the Related Arts

Hierarchical Temporal Memory (HTM) systems represent a new approach to machine intelligence. In an HTM system, training data comprising temporal sequences and/or spatial patterns are presented to a network of nodes. The HTM network then builds a model of the statistical structure inherent in the spatial patterns and temporal sequences in the training data, which may be used to predict or recognize the temporal sequences of patterns and sequences in the training data. The hierarchical structure of the HTM system enables implementation of models of very high dimensional input spaces using reasonable amounts of memory and processing capacity.

The training process of the HTM system is largely a form of unsupervised machine learning. During a training process, one or more processing nodes of the HTM system form relationships between temporal sequences and/or spatial patterns present in training input and their associated causes or events.

Once an HTM system has built a model of a particular input space, it can perform inference or prediction. To perform inference or prediction, novel input including temporal sequences or spatial patterns are presented to the HTM system. During the inference stage, each node in the HTM system produces an output that is more invariant and temporally stable than its input. That is, the output from a node in the HTM system is more abstract and invariant compared to its input. At its highest node, the HTM system will generate an output indicative of the underlying cause or event associated with the novel input.

Input data to the HTM system may be in a format incompatible for processing by HTM system. Hence, an encoder receives the input data in a raw form and converts the input data into a distributed representation form. Different coding schemes may be applied to different data sets and data types to increase the performance of the HTM system. Distributed representations comprise a collection of active and inactive elements. Different inputs are associated with distributed representations having different permutations of active and inactive elements.

### SUMMARY

Embodiments relate to encoding coordinate data as a sparse distributed representation. Input coordinates represented in a coordinate space having at least one dimension are obtained. The input coordinates may change over time. A corresponding region around each of the input coordinates in the coordinate space is determined. For each of the input coordinates, a subset of coordinates for each of the input coordinates within the corresponding region is selected. For each of the input coordinates, a sparse distributed representation reflecting the selected subset of coordinates is generated. The sparse distributed representation includes a greater number of inactive elements than active elements.

In one embodiment, the subset of coordinates is selected by determining ranks for the plurality of coordinates within the corresponding region by processing the plurality of coordinates by a hashing algorithm selecting the subset of coordinates based on the determined ranks.

In one embodiment, the corresponding region around the input coordinate is determined according to a measure of change. The measure of change is obtained between the input coordinate and a next input coordinate in time, and a threshold distance within the coordinate space is determined that increases or decreases according to the measure of change. The corresponding region encompasses coordinates within the threshold distance from the input coordinate. The input coordinate and the next input coordinate may include geographical position data, and the measure of change is a speed derived from the geographical position data. The measure of change may be obtained from a dimension of the input coordinates that encodes the measure of change.

In one embodiment, the corresponding region around the input coordinate is determined according to two or more measures of change. A first measure of change associated with a first dimension of the input coordinate and a second measure of change associated with a second dimension of the input coordinate are obtained. A first threshold distance based on the first measure of change and a second threshold distance based on the second measure of change are determined. The corresponding region extends the first threshold distance from the input coordinate along the first dimension and the second threshold distance from the input coordinate along the second dimension.

In one embodiment, the subset of coordinates is selected according to a sparsity parameter indicating a number of active elements in the sparse distributed representation. The number of coordinates in the subset is equal to the number of active elements indicated by the sparsity parameter.

In one embodiment, the sparse distributed representation is generated according to a length parameter indicating a number of elements in the sparse distributed representation. Indices associated with each of the selected coordinates using a hashing algorithm are determined, where the determined indices do not exceed the length parameter. The sparse distributed representation is determined to have active elements at the determined indices.

In on embodiment, input data having one or more dimensions is obtained, and one or more measures of change for the one or more dimensions of the input data are determined. The input coordinates are generated, where each input coordinate includes the one or more dimensions of the input data and the one or more measures of change.

In one embodiment, temporal sequences of spatial patterns are determined in the sparse distributed representations generated from the input coordinates.

### BRIEF DESCRIPTION OF THE DRAWINGS

The teachings of the embodiments of the present disclosure can be readily understood by considering the following detailed description in conjunction with the accompanying drawings.

FIG. 1 is a conceptual diagram illustrating relationships between a data source, an encoder, and a processing node, according to one embodiment.

FIG. 2A is a block diagram illustrating a coordinate analyzer, according to one embodiment.

FIG. 2B is a block diagram illustrating an encoder, according to one embodiment.

FIG. 3 is a flowchart illustrating a process of encoding input coordinates as a sparse distributed representation, according to one embodiment.

FIGS. 4A through 4D are conceptual diagrams of example regions around an input coordinate, according to various embodiments.

FIGS. 4E through 4G are conceptual diagrams of example regions around input coordinates associated with different measures of change, according to one embodiment.

FIGS. 5A through 5D are conceptual diagrams illustrating detection of anomalies from input coordinates, according to one embodiment.

FIG. 6 is a conceptual diagram illustrating example regions around scalar input data, according to one embodiment.

### DETAILED DESCRIPTION OF EMBODIMENTS

In the following description of embodiments, numerous specific details are set forth in order to provide more thorough understanding. However, note that the embodiments may be practiced without one or more of these specific details. In other instances, well-known features have not been described in detail to avoid unnecessarily complicating the description.

A preferred embodiment is now described with reference to the figures where like reference numbers indicate identical or functionally similar elements. Also in the figures, the left most digits of each reference number corresponds to the figure in which the reference number is first used.

Embodiments relate to encoding coordinate data as a sparse distributed representation for processing by a Spatial and Temporal Memory System (STMS). An encoder obtains input data from a data source and processes the input data to a discrete input coordinate. The encoder identifies a region containing the input coordinate and selects a subset of neighbor coordinates from the region according to a ranking of neighbor coordinates in the region. The encoder outputs a sparse distributed representation that has active elements each corresponding to a neighbor coordinate from the selected subset. The neighbor coordinates may be ranked according to consistent criteria so that as the distance between nearby input coordinates decrease, the number of active elements in common between their respective distributed representations increases. The size of the region may vary with a measure of change in the input coordinate.

A STMS as described herein refers to hardware, software, firmware or a combination thereof that is capable of learning and detecting spatial patterns and temporal sequences of spatial patterns in input data. The STMS stores temporal relationships in sequences of spatial patterns and generates useful information based on the stored relationships. The useful information may include, for example, predictions of spatial patterns to be received, predictions of missing parts of spatial patterns received, identifications of spatial patterns, or temporal sequences, or grouping patterns and sequences by similarity.

In some embodiments, the STMS is a spatial memory capable of learning and detecting spatial patterns, or the STMS is a temporal memory capable of learning and detecting temporal sequences. Other embodiments relate to encoding coordinate data as a distributed representation for processing by a system besides an STMS. For example, the encoder outputs a sparse distributed representation to a machine-learning classifier trained to detect spatial patterns.

Coordinate data as described herein refers to a grouping of one or more dimensions of data, including numerical and binary data. In one embodiment, coordinate data is generated by selecting one or more dimensions of input data associated with a time. Scalar data refers to coordinate data having one dimension of data.

### Example STMS

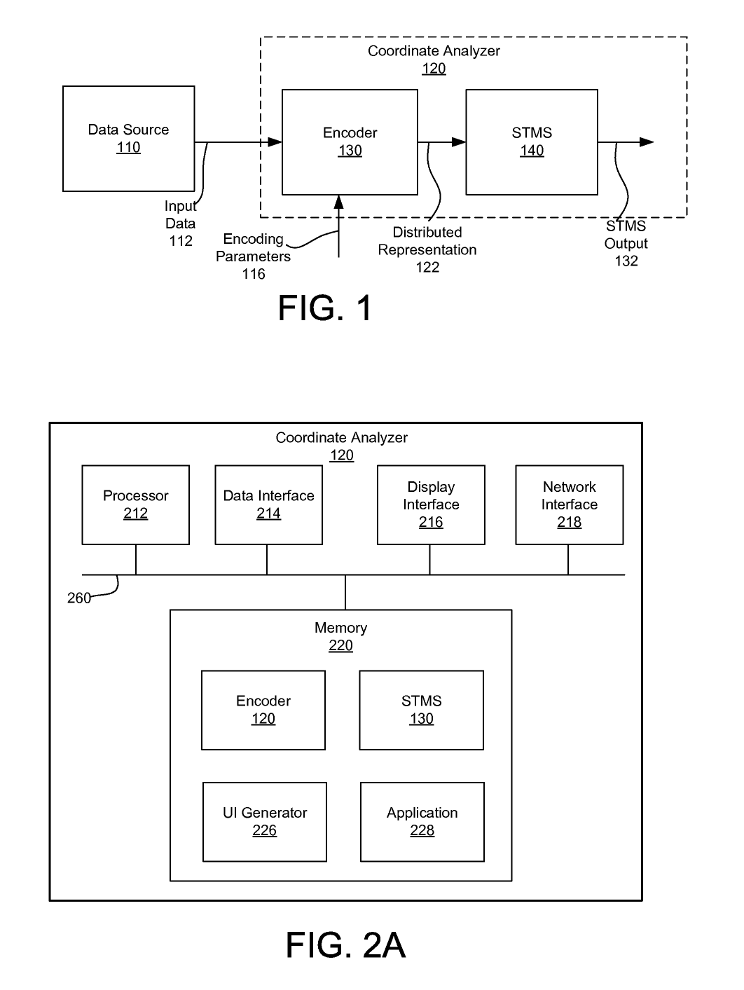

FIG. 1 is a conceptual diagram illustrating relationships between a data source 110, an encoder 130, and a STMS module 140, according to one embodiment. The encoder 130 and STMS module 140 are included in a coordinate analyzer 120 that evaluates input data 112 from the data source 110. Although one of each component is illustrated, various embodiments may include multiple instances of components (e.g., multiple data sources 110, multiple STMS modules 140).

The data source 110 may be any source outputting input data 112 that may be encoded for processing by an STMS. Typically, data sources 110 output one or more dimensions of input data 112, which vary with time. The one or more dimensions of input data 112 may be converted to a coordinate encoded as a distributed representation. Example data sources 110 include (i) a usage monitor of a webserver (e.g., physical, cloud, virtual) outputting input data 112 such as page loads, downloads, uploads, purchases, or clicks; (ii) a financial data source outputting input data 112 such as stock prices, trading volume, company financial data, commodity prices, or currency exchange rates; (iii) a traffic data source outputting input data 112 such as vehicle speed or volume at different points in a transit system; (iv) a weather center outputting input data 112 such as wind speed, temperature, pressure, and humidity at various weather stations; and (v) a location sensor outputting input data 112 such as latitude, longitude, altitude, or speed. For example, the location sensor outputs input data 112 representing geographic location and speed of a child's phone, a pet's collar, a package delivery truck, a shipping container, or an airplane.

The encoder 130 obtains the input data 112 and outputs a distributed representation 122 that reflects the encoding parameters 116 of the encoder 130. The encoder 130 includes an encoding scheme for converting input data 112 to a distributed representation 122. The encoding scheme may specify selection of dimensions of the input data 112 to form an input coordinate. The encoding scheme may specify parameters for performing various preprocessing on the input data 112.

A distributed representation 122 refers to a format for representing data. Data in a distributed representation form has a limited number of elements (e.g., hundreds or thousands of elements), some of which are active while the remaining elements are inactive. A special case of the distributed representation form 122 is the sparse distributed representation form, where the number of active (or inactive) elements is comparatively smaller than the total number of elements.

The encoding parameters 116 modify the form of the distributed representation 122. The encoding parameters 116 include a length parameter and a sparsity parameter. The length parameter indicates a total number (e.g., 100) of elements (including active elements and/or inactive elements) in the distributed representation 122. The sparsity parameter indicates a number (e.g., 10) of active elements out of the total number of elements in the distributed representation 122. Accordingly, the encoder 130 generates distributed representations having a set number of active and inactive elements based on the encoding parameters 116. When the sparsity parameter indicates that the number of active elements is less than the number of inactive elements, the distributed representation 122 is a sparse distributed representation.

The STMS module 140 learns and detects spatial patterns and temporal sequences of spatial patterns in input data 112 based on distributed representations 122. The STMS module 140 may include a single processing node or a plurality of processing nodes. The processing nodes may be hierarchically arranged. The STMS module 140 generates the STMS output 132, which can be used for various applications. The STMS output 132 may also vary over time. The STMS output 132, however, typically represents a high-level abstraction of the input data and is invariant and steady relative to fluctuations in the input data 112. In one embodiment, a processing node in the STMS module 140 is embodied, for example, as described in U.S. patent application Ser. No. 13/046,464 entitled “Temporal Memory Using Sparse Distributed Representation, filed on Mar. 11, 2011, which is incorporated by reference herein in its entirety.

### Example Architecture of Coordinate Analyzer

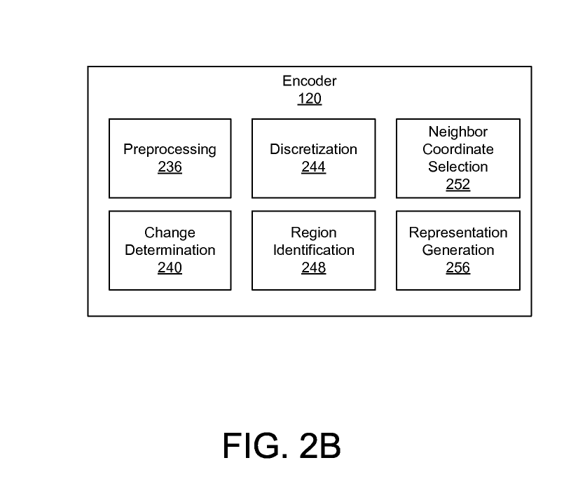

FIG. 2A is a block diagram illustrating a coordinate analyzer 120, according to one embodiment. The coordinate analyzer 120 receives the input data 112 and analyzes the input data 112. Analyzing input data 112 includes, for example, performing spatial pattern recognition, temporal sequence detection, future input prediction, and anomaly detection. In one embodiment, the coordinate analyzer 120 is embodied as one or more servers communicatively connected to another device functioning as a data source 110. Alternatively or additionally, the coordinate analyzer 120 may be part of a computing system that also forms a data source 110.

The coordinate analyzer 120 may include, among other components, a processor 212, a data interface 214, a display interface 216, a network interface 218, a memory 220, and a bus 260 connecting these components. One or more software components in the memory 220 may also be embodied as a separate hardware or firmware component in the coordinate analyzer 120. The coordinate analyzer 120 may include components not illustrated in FIG. 2 (e.g., an input device and a power source).

The processor 212 reads and executes instructions from the memory 220. The processor 212 may be a central processing unit (CPU) and may manage the operation of various components in the coordinate analyzer 120. The processor 212 may have multiple cores and/or include multiple processors 212.

The data interface 214 is hardware, software, firmware, or a combination thereof for receiving the input data 112. The data interface 214 may be embodied as a networking component (e.g., a port, an antenna) to receive the input data over a network from another computing device. Alternatively or additionally, the data interface 214 may be a sensor interface that is connected to one or more sensors that generate the input data 112. In some embodiment, the data interface 214 may convert analog signals from sensors into digital signals.

The display interface 216 is hardware, software, firmware, or a combination thereof for generating display data to be displayed on a display device. The display interface 216 may be embodied as a video graphics card. In one embodiment, the display interface 216 enables a user to view a graphical user interface displaying recognized patterns, detected sequences, predictions, or detected anomalies based on the input data 112.

The network interface 218 is hardware, software, firmware, or a combination thereof for receiving input data 112 or providing results of an analysis of the input data 112. The network interface 218 may enable the coordinate analyzer 120 to service multiple devices with analyzed coordinate data.

The memory 220 is a non-transitory computer readable storage medium that stores software components including among others, an encoder 130, an STMS module 140, a user interface (UI) generator 226, and an application 228. The memory 220 may store other software components not illustrated in FIG. 2, such as an operating system. The memory 220 may be implemented using various technologies including random-access memory (RAM), read-only memory (ROM), hard disk, flash memory and a combination thereof.

The application 228 is a software component that provides various services using STMS output 312. Various services may include, for example, (i) monitoring load and operation at a webserver (e.g., physical, cloud, virtual) at a certain IP address; (ii) predicting stock prices, trading volume, company financial data, commodity prices, or currency exchange rates; (iii) analyzing speed, volume, or routes of vehicles; (iv) predicting weather using wind speed, temperature, pressure, and humidity detected at various weather stations; and (v) detecting anomalies in movement of an entity (e.g., a person, a pet, a package delivery truck, a shipping container, a car and an airplane). The application 228 may provide other services using STMS output 312 such as, for example, (i) generating movement instructions for an autonomous vehicle according to inputs from a camera, radar, and a location sensor; and (ii) generating manipulator control signals in response to inputs from pressure sensors, microphones, and cameras. The application 228 may send generated output to the UI generator 226.

The UI generator 226 receives anomaly parameter values and generates graphical user elements such as charts or listings for presentation to the user. Based on instructions from the application 228, the UI generator 226 may adjust the granularity of time periods in the charts or listings.

### Example Architecture of Encoder

FIG. 2B is a block diagram illustrating an encoder 130, according to one embodiment. The encoder 130 includes a change determination module 240, a discretization module 244, a region identification module 248, a neighbor coordinate selection module 252, and a representation generation module 256. In other embodiments, the encoder 130 may include additional, fewer, or different modules that perform the functionality described herein.

The preprocessing module 236 obtains input data 112 and provides converted input data to facilitate processing by the change determination module 240 and discretization module 244. The preprocessing module 236 may perform one or more of (i) converting the input data 112 to standard units, (ii) reducing noise in the input data 112 (e.g., applying a moving average to the input data 112, omitting input data 112 associated with a measure of uncertainty exceeding a threshold uncertainty), (iii) aggregating the input data 112 (e.g., averaging data in consecutive time windows to reduce the sampling rate), and (iv) deriving secondary quantities from the input data 112 (e.g., a measure of change, a binary comparison to a threshold, a measure of variance over a sliding time window). For example, the processing module 236 may convert input data 112 representing geographic coordinates (e.g., latitude and longitude) to a planar, perpendicular coordinate system using a map projection representing of a geographic area encompassing the input data 112. Such a conversion may reduce distortion at locations where projections developed for use in distant or larger geographic areas distort distances (e.g., a Mercator projection in polar latitudes).

The change determination module 240 obtains input data 112 (or converted input data from the preprocessing module 236) and determines a measure of change in one or more dimensions of the input data 112 over time. For this purpose, the change determination module 240 may compute a numerical derivative of raw input data 112 or smoothed input data 112 (e.g., with a moving average or data fit). For example, the change determination module 240 determines the measure of change from a vector difference between temporally adjacent coordinates. The measure of change is, for example, the speed at which an entity traverses geographic coordinates. The change determination module 240 may determine such speed from the magnitude of a vector representing orthogonal components of velocity of the entity. In some embodiments, the input data 112 itself may include a measure of change. In such a case, processing at the change determination module 240 may be obviated.

The discretization module 244 obtains converted input data from the preprocessing module 236 and provides a discretized input coordinate by rounding, applying a floor or applying a ceiling to the converted input data. For instance, an input coordinate is discretized to a nearest coordinate in a rectilinear array of coordinates, or a non-integer coordinate value is rounded to a nearest integer. In one embodiment, the spacing of discrete coordinates or scalars is described by the encoding parameters 116. Discretization may reduce the precision of input data 112, but the encoding process described herein may encode a coordinate consistently even with small fluctuations in the input data 112 associated with the coordinate. In some embodiments, the discretization module 244 obtains input data 112, performs discretization, and provides the discretized input data to the preprocessing module 236. In some embodiments, the processing module 236 performs discretization to provide converted input data.

In some embodiments, the input coordinate provided by the discretization module 244 incorporates a measure of change determined from the input data 112 by the change determination module 240. For example, an input coordinate includes two dimensions describing a location and one dimension describing a speed.

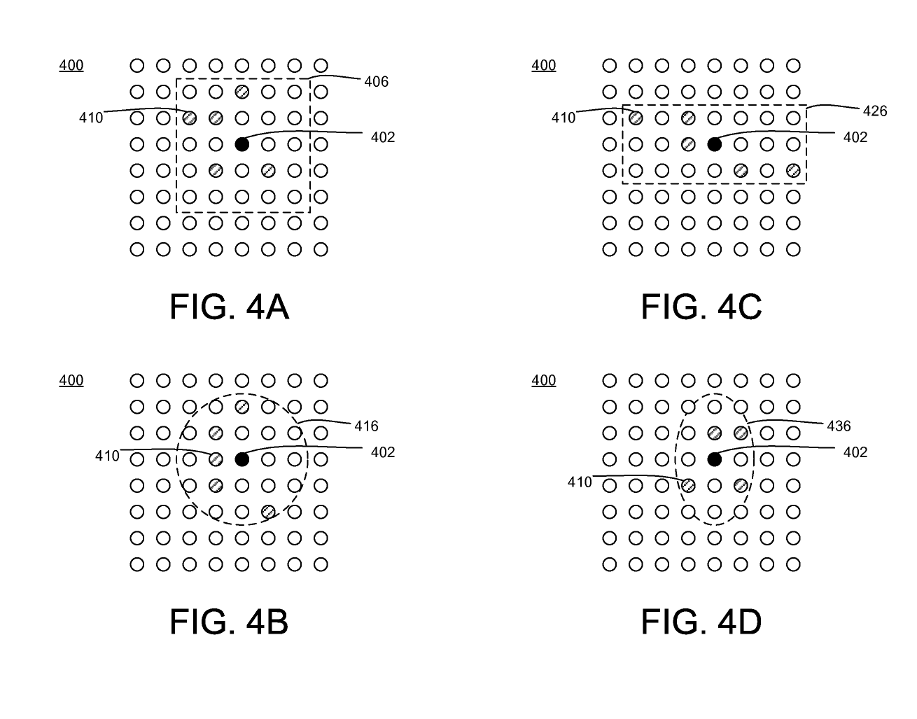

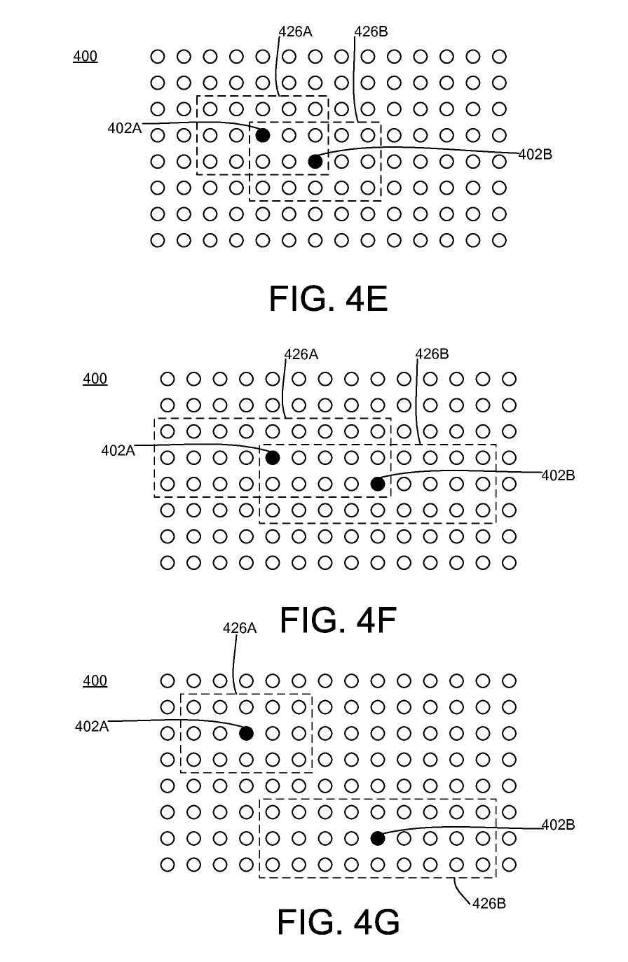

The region identification module 248 obtains an input coordinate (typically a discretized input coordinate) and identifies a region including the input coordinate and neighbor coordinates. The region identification module 248 may determine a region around a discretized input coordinate within a threshold distance of the input coordinate. For instance, the distance is the L2 norm (Cartesian distance) or L1 norm (Manhattan distance). The region may be a shape centered on the input coordinate. The shape may be two-dimensional (e.g., a circle, an ellipse, a square and a rectangle), as described below in detail with reference to FIGS. 4A through 4D. Further, the shape may be three-dimensional (e.g., a sphere, a cube, an ellipsoid, or a rectangular prism) or N-dimensional (e.g., a hypersphere or a hypercube).

The dimensions of the shape or the threshold distance may be fixed or may be variable according to a measure of change. For instance, the region identification module 248 determines that the region is a circle with a radius proportional to a measure of change as determined by the change determination module 240. The region identification module 248 may also determine that the region includes coordinates within a threshold distance proportional to the measure of change, as described below in detail with reference to FIGS. 4E through 4G. The precision of coordinate data may decrease as the measure of change increases, and increasing the size of the region reflects this decreased precision.

The size of the identified region may be determined to ensure overlap between regions identified for successive input coordinates. For instance, the region identified for an input coordinate may contain a most recent previous input coordinate. As a result of the overlap between regions of successive coordinates, successive distributed representations 122 generated for successive input coordinates have active elements in common. These common active elements provide similar distributed representations 122 for proximate input coordinates. As the distance between two input coordinates decreases, the number of active elements in common between their respective distributed representations 122 increases.

The region identification module 248 may determine the size of the identified region according to a measure of uncertainty associated with the input data 112. The measure of uncertainty is a quantified indication of imprecision of the input data 112. For example, the input data 112 includes a dimension indicating a latitude and longitude of a position and a radius of uncertainty around the position. The size of the identified region may increase or decrease according to the measure of uncertainty. For example, the size of the identified region increases as the measure of uncertainty increases to reflect decreased confidence in the input data 112.

The neighbor coordinate selection module 252 obtains the region of neighbor coordinates and selects a subset of neighbor coordinates from neighbor coordinates in the region. The neighbor coordinate selection module 252 ranks the neighbor coordinates and selects a subset of the neighbor coordinates based on the ranking. For instance, the neighbor coordinates are ranked by applying a ranking hash function to determine a hash value corresponding to each neighbor coordinate and then determining a rank for each neighbor coordinates according to the hash value. A hash function (e.g., a uniform hash function) deterministically maps input data to an output. As another example, the rank is determined by generating a pseudo-random number from a seed corresponding to the neighbor coordinate. Using a hash function to rank the neighbor coordinates beneficially provides repeatable ranks, which results in more consistently generating the distributed representation for an input coordinate.

Alternatively or additionally, the ranking reflects a distance from the input coordinate. For example, the rank of a neighbor coordinate is proportional to a hash value of the neighbor coordinate and a decay factor (e.g., a Gaussian, exponential, or power law function) determined from the distance between the input coordinate and neighbor coordinate. Ranking neighbor coordinates according to distance from the input coordinate may obviate identifying a region of neighbor coordinates around the input coordinate, as is done by the region identification module 248. However, identifying a region of neighbor coordinates reduces the number of neighbor coordinates to rank and accordingly increases computational efficiency.

The number of neighbor coordinates in the selected subset may be determined by the sparsity parameter. For instance, if the sparsity parameter indicates ten active elements in the distributed representation, then the neighbor coordinate selection module 252 selects ten neighbor coordinates.

The representation generation module 256 obtains the selected subset of neighbor coordinates and generates a distributed representation 122 reflecting the selected neighbor coordinates. The representation generation module 256 applies an indexing hashing function to the selected subset of neighbor coordinates to determine an index associated with each neighbor coordinate. The representation generation module 256 generates a distributed representation having active elements at the determined indices. In one embodiment, the indexing hashing function maps each coordinate to a discrete value (e.g., an integer) such that the range of potential indices equals the length parameter of the sparse distributed representation. Using a uniform hashing function for indexing beneficially reduces the potential for different coordinates to have the same distributed representation. For example, the hashing function is applied by (a) converting the neighbor coordinate to a string in a particular format (e.g., with commas between dimensions of the neighbor coordinate); (b) using the string as input to a hashing function (e.g., MD5 (message-digest five), SHA1 (secure hash algorithm one), SHA2); and (c) converting the output of the hashing function to another format to facilitate manipulation or comparison (e.g., an integer). The representation generation module 256 may generate both sparse and non-sparse distributed representations.

### Example Process of Generating a Distributed Representation

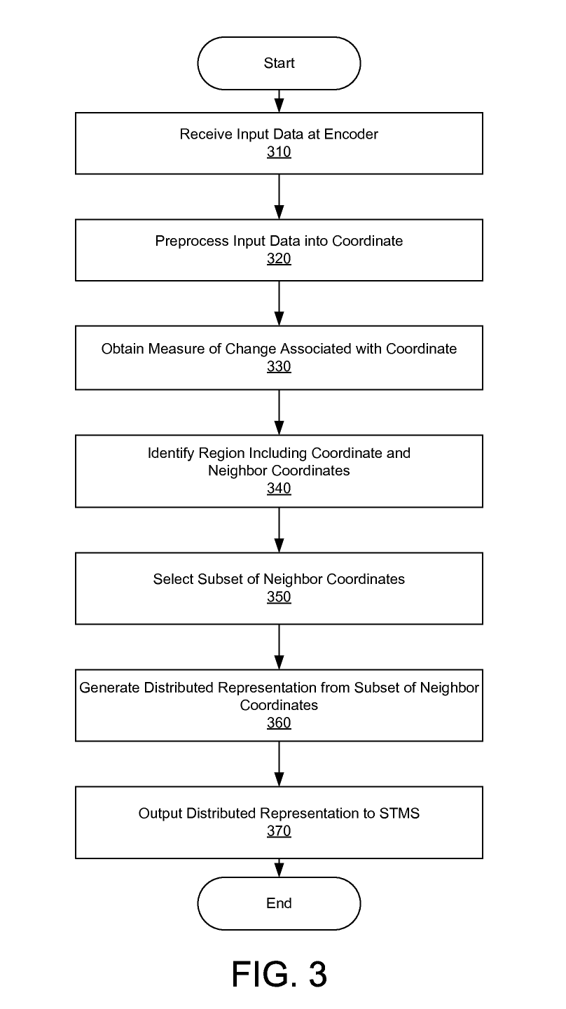

FIG. 3 is a flowchart illustrating a process of encoding input coordinates as a sparse distributed representation, according to one embodiment. For explanatory purposes, the data source 110 is a location sensor on a shipping container, and the input data 112 include latitude and longitude data. However, any input data 112 (whether one-dimensional or multi-dimensional) may be used.

The encoder 130 receives 310 the geographic coordinates from the location sensor. The preprocessing module 236 and/or the discretization module 244 preprocesses 320 the input data by converting it to an input coordinate. For example, the preprocessing module 236 converts the latitude and longitude data to a rectilinear projection, and the discretization module 244 generates a discretized coordinate from the projected latitude and longitude data.

The change determination module 240 obtains 330 a measure of change associated with the coordinate. For example, the measure of change is a speed determined based on a comparison with the previous known location of the location sensor relative to time.

The region identification module 248 identifies 340 a region containing the input coordinate and neighbor coordinates. For example, the region is a square having a side length proportional to the determined speed of the shipping container.

The neighbor coordinate selection module 252 selects 350 a subset of the neighbor coordinates in the identified region. The representation generation module 256 generates 360 the distributed representation based on the selected subset of neighbor coordinates, and the encoder 130 outputs 370 the distributed representation to the STMS module 140.

The process described in FIG. 3 may be repeated for at a subsequent time step. At each time step, a different distributed representation 122 may be produced by the encoder 130 as the input data 112 changes.

### Example Regions Around an Input Coordinate

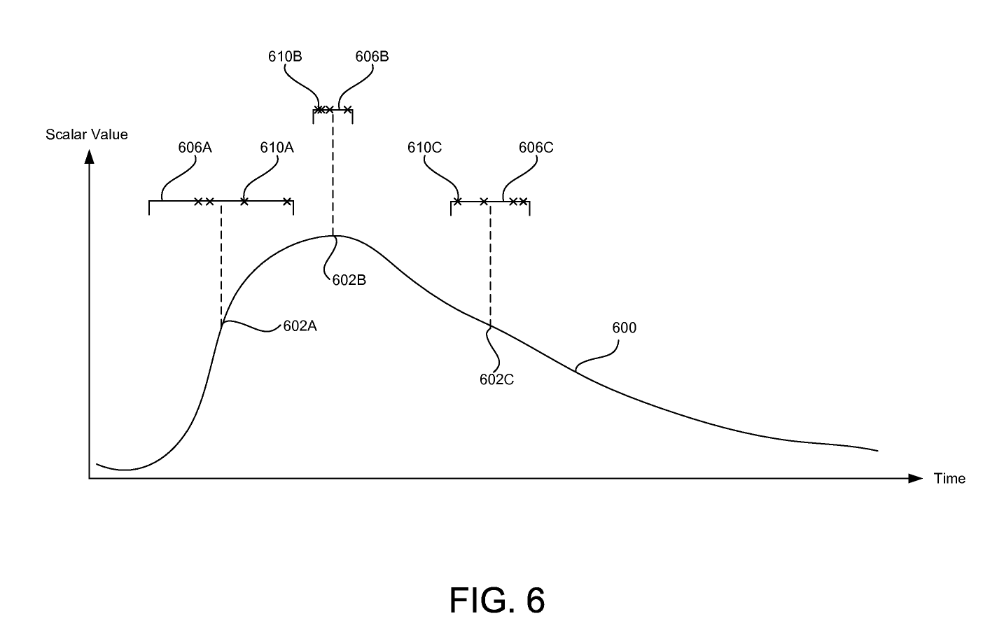

FIGS. 4A through 4D are conceptual diagrams of example regions 406 around an input coordinate 402, according to various embodiments. The input coordinate is illustrated in an array 400 of discrete coordinates. A region includes an input coordinate 402 and neighbor coordinates. A subset of neighbor coordinates 410 are selected and hashed to determine which elements of the distributed representation are active. Although illustrated with respect to two-dimensional input data, other input data having three or more dimensions may have corresponding regions encompassing three or more dimensions, and other input data having one dimension may have corresponding one-dimensional ranges, as described further with respect to FIG. 6.

FIG. 4A illustrates a square region 406. FIG. 4B illustrates a circular region 416. The side length of the square region 406 and the radius of the circular region 416 may be determined by an aggregate measure of change (e.g., speed) in the two dimensions (location coordinates) of the input coordinate 402. For example, the side length or the radius may increase as the measure of change increases, and the side length or the radius may decrease as the measure of change decreases.

FIG. 4C illustrates a rectangular region 426 having a vertical height less than its horizontal width. FIG. 4D illustrates an oval region 436 having a major diameter and a minor diameter. The dimensions of the regions 426 and 436 may be based on individual measures of change in the two coordinate variables. For example, the height and width of the rectangular region 416 may be based on vertical velocity and horizontal velocity components, respectively. Similarly, the major and minor diameters of the oval region 436 may be based on vertical and horizontal velocities, respectively.

FIGS. 4E through 4G are conceptual diagrams of example regions around input coordinates associated with different measures of change, according to one embodiment. Illustrated are a first input coordinate 402A received at a first time and a second input coordinate 402B received at a second time. The first and second input coordinates 402A and 402B have corresponding regions 416A and 416B respectively. In FIG. 4E, the input coordinates 402A and 402B have a first horizontal velocity, and the rectangular regions 402A and 402B have a first horizontal width based on the horizontal velocity. In FIG. 4F, the input coordinates 402A and 402B have a second horizontal velocity greater than the first horizontal velocity. Accordingly, the rectangular regions 426A and 426B in FIG. 4F have a second horizontal width greater than the first horizontal width. In both FIGS. 4E and 4F, the input coordinates 402A and 402B have a same vertical velocity, so their respective rectangular regions 426A and 426B have a same vertical height. In the example of FIGS. 4E and 4F, the horizontal and vertical velocities may be determined from a difference in the respective positions of the input coordinates 402A and 402B.

In FIG. 4G, the input coordinate 402A has the first horizontal velocity less than a second horizontal velocity of input coordinate 402B. Accordingly, the rectangular region 426A has a first horizontal width less than the second horizontal width of rectangular region 426B. The input coordinates 402A and 402B have a same vertical velocity, so their respective rectangular regions 426A and 426B have a same vertical height. In the example FIG. 4G, the horizontal and vertical velocities may be obtained from input data (e.g., from a speedometer or accelerometer) rather than derived from changes in positions of the input coordinates 402A and 402B.

Example Detection of Anomalies from Input Coordinates

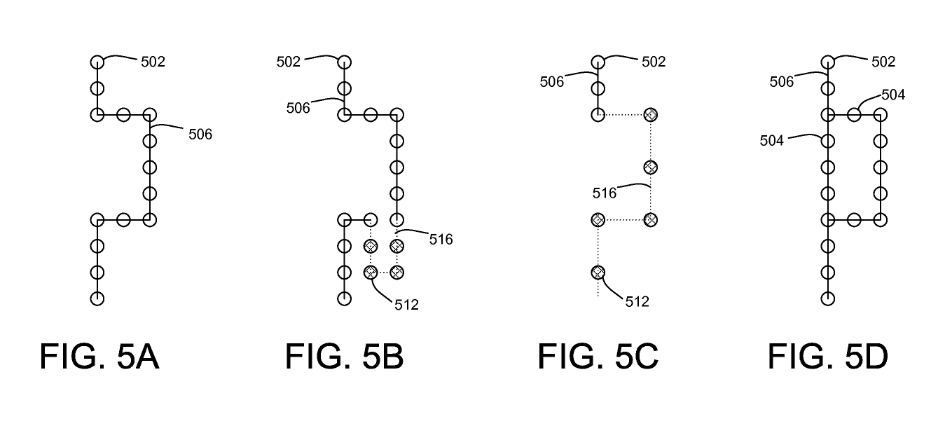

FIGS. 5A through 5D are conceptual diagrams illustrating detection of anomalies from input coordinates, according to one embodiment. Although described with respect to an application 228 monitoring movement of a delivery truck for anomalies, other input data 112 may be used or may be analyzed differently.

FIG. 5A illustrates a habitual path 506 across geographic locations traveled by a truck on a delivery route. As the truck travels, a location sensor reports input coordinates 502. The encoder 120 converts the input coordinates 502 to distributed representations provided to the STMS module 130. Repeated exposures to the input coordinates trains the STMS module 130 to recognize the temporal sequence of input coordinates 502 and to predict a next coordinate in the temporal sequence. To detect anomalies, the application 228 compares distributed representations encoding predicted coordinates output by the STMS module 130 to distributed representations encoding actual input coordinates 502.

While the truck is driving the route, the application 228 compares a distributed representation encoding an actual input coordinate 502 received from the truck's location sensor with a distributed representation encoding a next coordinate predicted by the STMS module 130 according to patterns and sequences learned from distributed representations encoding previous input coordinates 502. The application 228 generates an anomaly score that increases when the distributed representation encoding the actual input coordinate 502 differs from the distributed representation encoding the predicted next coordinate. The anomaly score may be generated using a scheme described, for example, in U.S. patent application Ser. No. 14/014,237 entitled “Anomaly Detection in Spatial and Temporal Memory System” filed on Aug. 29, 2013 (U.S. Patent Application Publication No. 2014/0067734), which is incorporated by reference herein in its entirety.

The application 228 may translate the anomaly score into a binary assessment (e.g., none, present) or qualitative assessment (e.g., none, low, medium, high) of the presence of an anomaly. In one embodiment, the application 228 detects an anomaly if the anomaly score equals or exceeds a threshold score.

In the example of FIG. 5A, the distributed representations encoding input coordinates 502 match the distributed representations encoding predicted next coordinates on the habitual path 506. Accordingly, the application 228 determines a low anomaly score and indicates that no anomaly is present.

FIG. 5B illustrates deviation 516 from the habitual path 506. When an irregular input coordinate 512 is encoded and provided to the STMS module 130, the application 228 determines that the distributed representation encoding the predicted input coordinate does not match the distributed representation encoding the irregular input coordinate 512. Accordingly, the application 228 indicates the presence of an anomaly with respect to the irregular input coordinates 512 while indicating no anomaly with respect to the input coordinates 502 on the habitual path 506.

FIG. 5C illustrates another deviation 516 from the habitual path 506. Even though the deviation 516 overlaps spatially with the habitual path 506, the deviation 516 does not overlap temporally because the speed is greater than normal. When an irregular input coordinate 512 is encoded and provided to the STMS module 130, the application 228 determines that the distributed representation encoding the predicted input coordinate does not match the distributed representation encoding the irregular input coordinate 512 because the irregular input coordinate 512 is farther along the habitual path than predicted. Even if the irregular input coordinate 512 were in the same position as the predicted input coordinate, the difference in speed could nonetheless result in detection of an anomaly due to a resulting difference in region size used to select the neighbor coordinates to generate the distributed representations encoding the respective coordinates. Accordingly, the application 228 indicates the presence of an anomaly.

FIG. 5D illustrates another habitual path 506 traveled by a truck on a delivery route. The other habitual path 506 includes a fork in the middle where the truck sometimes takes a direct route (illustrated on the left) and sometimes takes a more roundabout route (illustrated on the right). As the truck uses both variations regularly, the STMS module 130 learns two distinct temporal sequences to account for the two different variations in the habitual path 506. Accordingly, after the truck takes the fork, the STMS module 130 predicts distributed representations encoding the two possible input coordinates 504. When the next input coordinate is received, the application 228 determines that one of the distributed representations matches the distributed representation encoding the input data. Accordingly, the application 228 indicates that no anomaly is present even though a distributed representation encoding one of the predicted input coordinates 504 does not match the distributed representation encoding the actual next input coordinate.

### Example Encoding of One-Dimensional Data

FIG. 6 is a conceptual diagram illustrating example regions 606 around scalar input data 600, according to one embodiment. The principles described above may be applied to scalar values (i.e., one-dimensional coordinates).

Illustrated is a graph of scalar input data 600 over time, including three instances of input data 602A through 602C. The discretization module 244 may discretize a scalar input to a scalar input coordinate. The region identification module 248 identifies a one-dimensional region, referred to as a range 606. In the illustrated embodiment of FIG. 6, the range 606 is a symmetrical interval around the instance of input data 602. The width of the range 606 is based on a derivative of the scalar input data 600 at the instance of input data 602. Accordingly, the range 606A is wider than the range 606B because the measure of change associated with the input data 602A is greater than the measure of change associated with the input data 602B.

The neighbor coordinate selection module 252 selects a subset of neighbor coordinates 610 within the corresponding range 606. Based on the selected subset of neighbor coordinates 610, the representation generation module 256 generates a distributed representation of the scalar input data.

Although the above embodiments were described primarily with respect to generating distributed representations for processing by a STMS, the same principles may be used to generate distributed representations of coordinates for other machine-intelligence systems that use distributed representations.

Upon reading this disclosure, those of skill in the art will appreciate still additional alternative designs for processing nodes. Thus, while particular embodiments and applications have been illustrated and described, it is to be understood that the embodiments are not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

1. A method for encoding coordinate data, the method comprising:
obtaining input coordinates represented in coordinate space having at least one dimension, the input coordinates changing over time;
determining a corresponding region around each of the input coordinates in the coordinate space;
selecting a subset of coordinates within the corresponding region for each of the input coordinates; and
generating a sparse distributed representation for each of the input coordinates reflecting the selected subset of coordinates for each of the input coordinates, the sparse distributed representation comprising a greater number of inactive elements than active elements.

2. The method of claim 1, wherein selecting the subset of coordinates comprises:
determining ranks for the plurality of coordinates within the corresponding region by processing the plurality of coordinates by a hashing algorithm; and
selecting the subset of coordinates based on the determined ranks.

3. The method of claim 1, wherein determining the corresponding region around an input coordinate comprises:
obtaining a measure of change between the input coordinate and a next input coordinate in time; and
determining a threshold distance within the coordinate space that increases or decreases according to the measure of change, the corresponding region encompassing coordinates within the threshold distance from the input coordinate.

4. The method of claim 3, wherein the input coordinate and the next input coordinate comprise geographical position data, and wherein the measure of change is a speed derived from the geographical position data.

5. The method of claim 1, wherein determining the corresponding region around an input coordinate comprises:
obtaining a first measure of change associated with a first dimension of the input coordinate and a second measure of change associated with a second dimension of the input coordinate; and
determining a first threshold distance based on the first measure of change and a second threshold distance based on the second measure of change, the corresponding region extending the first threshold distance from the input coordinate along the first dimension and the second threshold distance from the input coordinate along the second dimension.

6. The method of claim 1, wherein determining the corresponding region around an input coordinate comprises:
obtaining a measure of uncertainty associated with the input coordinate; and
determining a threshold distance within the coordinate space that increases or decreases according to the measure of uncertainty, the corresponding region determined to encompass coordinates within the threshold distance from the input coordinate.

7. The method of claim 1, wherein selecting the subset of neighbor coordinates comprises:
obtaining a sparsity parameter indicating a number of active elements in the sparse distributed representation; and
selecting a number of coordinates in the corresponding region, the number being equal to the number of active elements indicated by the sparsity parameter.

8. The method of claim 1, wherein generating the sparse distributed representation for an input coordinate comprises:
obtaining a length parameter indicating a number of elements in the sparse distributed representation;
determining indices associated with each of the selected coordinates using a hashing algorithm, the determined indices not exceeding the length parameter;
generating the sparse distributed representation having active elements at the determined indices.

9. The method of claim 1, wherein obtaining the input coordinates comprises:
obtaining input data comprising one or more dimensions;
determining one or more measures of change for the one or more dimensions of the input data; and
generating the input coordinates, each input coordinate comprising the one or more dimensions of the input data and the one or more measures of change.

10. The method of claim 1, further comprising determining temporal sequences of spatial patterns in sparse distributed representations generated from the input coordinates.

11. A non-transitory, computer-readable storage medium storing instructions thereon, the instructions when executed by a processor causing the processor to:
obtain input coordinates represented in coordinate space having at least one dimension, the input coordinates changing over time;
determine a corresponding region around each of the input coordinates in the coordinate space;
select a subset of coordinates within the corresponding region for each of the input coordinates; and
generate a sparse distributed representation for each of the input coordinates reflecting the selected subset of coordinates for each of the input coordinates, the sparse distributed representation comprising a greater number of inactive elements than active elements.

12. The medium of claim 11, wherein instructions for selecting the subset of coordinates comprise instructions causing the processor to:
determine ranks for the plurality of coordinates within the corresponding region by processing the plurality of coordinates by a hashing algorithm; and
select the subset of coordinates based on the determined ranks.

13. The medium of claim 11, wherein instructions for determining the corresponding region around an input coordinate comprise instructions causing the processor to:
obtain a measure of change between the input coordinate and a next input coordinate in time; and
determine a threshold distance within the coordinate space that increases or decreases according to the measure of change, the corresponding region encompassing coordinates within the threshold distance from the input coordinate.

14. The medium of claim 11, wherein instructions for determining the corresponding region around an input coordinate comprise instructions causing the processor to:
obtain a first measure of change associated with a first dimension of the input coordinate and a second measure of change associated with a second dimension of the input coordinate; and
determine a first threshold distance based on the first measure of change and a second threshold distance based on the second measure of change, the corresponding region extending the first threshold distance from the input coordinate along the first dimension and the second threshold distance from the input coordinate along the second dimension.

15. The medium of claim 11, wherein instructions for selecting the subset of neighbor coordinates comprise instructions causing the processor to:
obtain a sparsity parameter indicating a number of active elements in the sparse distributed representation; and
select a number of coordinates in the corresponding region, the number being equal to the number of active elements indicated by the sparsity parameter.

16. The medium of claim 11, wherein instructions for generating the sparse distributed representation for an input coordinate comprise instructions causing the processor to:
obtain a length parameter indicating a number of elements in the sparse distributed representation;
determine indices associated with each of the selected coordinates using a hashing algorithm, the determined indices not exceeding the length parameter;
generate the sparse distributed representation having active elements at the determined indices.

17. The medium of claim 11, wherein instructions for obtaining the input coordinates comprise instructions causing the processor to:
obtain input data comprising one or more dimensions;
determine one or more measures of change for the one or more dimensions of the input data; and
generate the input coordinates, each input coordinate comprising the one or more dimensions of the input data and the one or more measures of change.

18. The medium of claim 11, further comprising instructions causing the processor to determine temporal sequences of spatial patterns in sparse distributed representations generated from the input coordinates.

19. A computing system for encoding coordinate data, the computer system comprising:
a processor;
a data interface configured to obtain input data from one or more data sources; and
an encoder configured to:
obtain input coordinates represented in coordinate space having at least one dimension via the data interface, the input coordinates changing over time;
determine a corresponding region around each of the input coordinates in the coordinate space;
select a subset of coordinates within the corresponding region for each of the input coordinates; and
generate a sparse distributed representation for each of the input coordinates reflecting the selected subset of coordinates for each of the input coordinates, the sparse distributed representation comprising a greater number of inactive elements than active elements.

20. The computing system of claim 19, further comprising a STMS (spatial and temporal memory system) module configured to determine temporal sequences of spatial patterns in sparse distributed representations generated from the input coordinates.
